(19) United States
(12) Patent Application Publication
(10) Pub. No.: US 2022/0396685 A1
(43) Pub. Date: Dec. 15, 2022

(54) BIODEGRADABLE POLYMER NANOCOMPOSITE AND METHOD FOR PRODUCTION THEREOF

(71) Applicant: Toraphene Limited, London (GB)

(72) Inventors: Gaute Juliussen, London (GB); Simon Broughton, London (GB)

(21) Appl. No.: 17/777,008

(22) PCT Filed: Nov. 16, 2020
(86) PCT No.: PCT/IB2020/060744

§ 371 Date: May 13, 2022

(30) Foreign Application Priority Data
Nov. 15, 2019 (GB) 1916650.3

(51) Int. Cl. C08K 7/00; C08J 3/20; C08L 67/04; C08L 1/12

(52) U.S. Cl. CPC C08K 7/00; C08J 3/203; C08L 67/04; C08L 1/12; C08K 2201/011; C08L 2201/06

(57) ABSTRACT

Disclosed is a method for producing biodegradable polymer nanocomposite, the method comprising dispersing a plurality of graphene nanoplatelets into a matrix of biodegradable polymer and extruding the matrix of biodegradable polymer containing the plurality of graphene nanoplatelets to obtain the biodegradable polymer nanocomposite.

### TECHNICAL FIELD

The present disclosure relates generally to methods for producing polymer; and more specifically, to methods for producing biodegradable polymer nanocomposite. Moreover, the present disclosure relates to biodegradable polymer nanocomposites used as biodegradable plastics.

### BACKGROUND

The invention of Bakelite brought about a revolution in materials by introducing truly synthetic plastic resins. Moreover, with advancement in plastics, they have been increasingly deployed in numerous applications, for example, packaging applications including containers, bottles, drums, trays, boxes, cups, food packaging, protection packaging, product packaging, and so forth.

However, synthetic plastics have been found to be persistent polluter of various environmental niches, from Mount Everest to bottom of sea. Since such plastic wastes are non-biodegradable, they tend to persist in nature. There is greater recent public appreciation that plastic waste is destroying the environment, including marine life as well as in the human food chain, particularly as it is broken into Nano-plastic particles. Moreover, the colossal amount of production of plastics (notably, 348 million metric tons in 2017) and improper disposal thereof has led to a world crisis that further contributes greatly to climate change. In this regard, more than 50% of plastics produced are single-use plastics, typically used for packaging and carrying.

Notably, many plastics are being replaced by bio-based plastics. Typically, the bio-based plastics are biologically synthesized plastics produced from natural origins, for example, plants, animals or micro-organisms. Specifically, the bio-based plastics are predominantly made from bacterial fermentation of carbohydrates (namely, starch) from renewable resources (for example, corn, cassava, and sugar cane/beet) or cellulose films derived from wood pulp. Bio-based plastics manufactured using cellulose films are highly permeable to (and will disintegrate when in contact with) water; and manufacture thereof employs toxic chemicals. Polylactic acid (PLA) is biodegradable (or compostable) only under specifically controlled environmental conditions (such as, constant exposure to a temperature of 60 degree Celsius or above). Moreover, the bio-based plastics are mechanically weak and brittle, having low impact resistance, fatigue resistance, heat resistance, thermal resistance and resistance towards Ultraviolet (UV) light. Such bio-based plastics make a poor barrier to gases, liquids and odour; and are more expensive to produce than conventional plastics.

Other bio-based plastics, for example certain Polyhydroxyalkanoates (PHAs) are fully biodegradable. These PHAs may be manufactured by bacterial ingestion of feedstocks in which micro-organisms (for example, Cuprividus necator) are deprived of certain nutrients (e.g. lack of macro elements such as phosphorus, nitrogen, or oxygen) and supplying an excess of carbon sources, wherein the carbon sources may include carbohydrates (for example, glucose, gluconate or acetate), fatty acids, fish solid waste and activated sludge. These PHAs are less dependent on farmland and are mechanically stronger and resilient as compared to starch bio-based plastics and cellulose bio-based plastics. However, these PHAs are not resistance to acids, have poor heat resistance, have poor barrier properties and limited functionalities.

Presently, coextrusion of the bio-based plastics (namely, PHAs, starch-based plastics, cellulose-based plastics, and the like) to add additional layers thereto (i.e. to provide a laminate) is performed to cope with poor properties of the bio-based plastics. In an example, a barrier layer is added to a bio-based plastic to make the bio-based plastic less permeable to water and gas diffusion. However, such multi-layer bio-based plastics are unrecyclable, too thick and uneconomic.

Alternatively, reinforcement particles are added to the bio-based plastics. For example, carbon microfibers are added to the bio-based plastics to add mechanical strength thereto, mica flakes are added to the bio-based plastics to make it less permeable to diffusion of water and gas, and the like. However, reinforcement particles only add one property, and adds new requirements for additional chemical additives to adjust, for example, rheology, dispersibility, and the like for the bio-based plastics. This renders final products that are more environmentally problematic and less economically attractive. Moreover, such addition of the reinforcement particles merely circumvents the problems associated with conventional bio-based plastics as it can only address one property at a time.

Therefore, in light of the foregoing discussion, there exists a need to overcome the aforementioned drawbacks associated with the conventional bio-based plastics as they are not fit-for-purpose, environmentally sustainable or economically viable.

### SUMMARY

The present disclosure seeks to provide a method for producing biodegradable polymer nanocomposite. The present disclosure also seeks to provide a biodegradable polymer nanocomposite. The present disclosure seeks to provide a solution to the existing problem of brittle, weak, environmentally unsustainable and economically inviable conventional biodegradable plastics having low impact resistance, heat resistance, and barrier resistance. An aim of the present disclosure is to provide a solution that overcomes at least partially the problems encountered in prior art, and provides a graphene-polymer nanocomposite that serves as an efficient biodegradable packaging and replacement of bio-based plastics.

In one aspect, an embodiment of the present disclosure provides a method for producing biodegradable polymer nanocomposite, the method comprising:
dispersing a plurality of graphene nanoplatelets into a matrix of biodegradable polymer; and
extruding the matrix of biodegradable polymer containing the plurality of graphene nanoplatelets to obtain the biodegradable polymer nanocomposite.

Optionally, the extrusion is performed using a single or multiple screw and barrel extruder.

More optionally, shear developed between screws or shear developed between a screw and a barrel of the screw and barrel extruder is sufficient to deagglomerate agglomerated graphene nanoplatelets in the matrix of biodegradable polymer. Such shear may develop in an annular space between the screw and the barrel or in the space adjacent two screws.

Optionally, the extrusion is performed using a more than one screw and heated barrel extruder.

More optionally, shear developed in a space between surfaces of two or more screws that are rubbing close to each other and/or in the annulus between the screws and the heated barrel of the screw and barrel extruder is sufficient to deagglomerate agglomerated graphene nanoplatelets in the matrix of biodegradable polymer.

Optionally, the extrusion is performed at a temperature in a range of 120 degree Celsius to 160 degree Celsius.

Optionally, the method further comprises cooling the biodegradable composite to room temperature.

Optionally, the plurality of graphene nanoplatelets is composed of:

functionalized graphene, doped graphene, graphene oxide, reduced graphene oxide, or a combination thereof.

Optionally, the method further comprises extruding the matrix of biodegradable polymer prior to dispersing the plurality of graphene nanoplatelets thereon.

Optionally, the matrix of biodegradable polymer nanocomposite is at least one of: natural polymer, synthetic polymer.

In another aspect, an embodiment of the present disclosure provides a biodegradable polymer nanocomposite, wherein the biodegradable polymer nanocomposite comprises a plurality of unagglomerated graphene nanoplatelets dispersed in biodegradable polymer.

Optionally, the graphene nanoplatelets dispersed in the biodegradable polymer are substantially all unagglomerated.

Embodiments of the present disclosure substantially eliminate or at least partially address the aforementioned problems in the prior art, and enables mechanically stronger, heat resistant and economical polymer nanocomposite that is environmentally sustainable and suitable for large-scale production.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a method for producing biodegradable polymer nanocomposite, the method comprising:
dispersing a plurality of graphene nanoplatelets into a matrix of biodegradable polymer; and
extruding the matrix of biodegradable polymer containing the plurality of graphene nanoplatelets to obtain the biodegradable polymer nanocomposite.

In another aspect, an embodiment of the present disclosure provides a biodegradable polymer nanocomposite, wherein the biodegradable polymer nanocomposite comprises a plurality of unagglomerated graphene nanoplatelets dispersed in biodegradable polymer.

The present disclosure provides a biodegradable polymer nanocomposite and a method for producing the biodegradable polymer nanocomposite. Typically, the biodegradable polymer nanocomposite as described herein, is a biodegradable polymer nanocomposite manufactured by dispersing the plurality of graphene nanoplatelets within a matrix of biodegradable polymer. The Biodegradable polymer nanocomposite may be used for packaging or for carrier bags.

In this regard, the plurality of graphene nanoplatelets dispersed in the matrix of biodegradable polymer used as conventional bio-based plastics remedies a multitude of shortcomings of the bio-based plastics (namely, biodegradable plastics). Specifically, the plurality of graphene nanoplatelets provides structural reinforcement to the matrix of biodegradable polymer. Hence, the biodegradable polymer nanocomposite is mechanically stronger, thinner, lighter and hence less wasteful and more economic. Additionally, the plurality of graphene nanoplatelets enhance barrier strength of the biodegradable polymer thereby substantially reducing permeability of liquid, gas and odour therethrough. Moreover, the biodegradable polymer nanocomposite prevents premature degradation of items stored therein by shielding it against Ultraviolet (UV) radiations. The biodegradable polymer nanocomposite has improved thermal properties thereby making it more heat resistant. Furthermore, faster manufacturing speed of the biodegradable polymer nanocomposite is possible as improved thermal properties of the plurality of graphene nanoplatelets enhances conduction and convection of the biodegradable polymer nanocomposite. In this regard, output speed of the biodegradable polymer nanocomposite is enhanced owing to faster rate of heating and cooling thereof; and further curing thereof. Subsequently, manufacturing cost of the biodegradable polymer nanocomposite is substantially reduced, thereby making its large-scale production feasible. The biodegradable polymer nanocomposite is fully decomposable (namely, biodegradable or compostable) bio-based plastic, wherein the biodegradable polymer nanocomposite is produced partly or wholly with biologically sourced polymers. The biodegradable polymer nanocomposite can be decomposed by the action of living organisms, usually microbes, into water, carbon dioxide, and biomass, in a given time frame.

The present disclosure discloses a method for producing biodegradable polymer nanocomposite. The biodegradable polymer nanocomposite is a graphene-infused polymer nanocomposite that is manufactured by dispersing graphene nanoplatelets into a polymer matrix.

Graphene is a single freestanding monolayer of graphite. Specifically, graphene is a two-dimensional carbon allotrope with carbon atoms arranged in a planar form in a honeycomb lattice. Optionally, graphene has a thickness of one atom, specifically, 0.34 nanometres (nm).

Optionally, graphene may be synthesised by any one of synthesis techniques: mechanical cleaving, chemical exfoliation, chemical synthesis or chemical vapour deposition. In an example, the synthesis technique employed to synthesise graphene may be mechanical cleaving. In such example, graphite or graphite oxide is mechanically exfoliated to obtain graphene sheets. In another example, the graphene may be synthesized by chemical vapour deposition. In such example, methane and hydrogen are reacted on a metal surface at high temperatures to deposit sheets of graphene thereon. In yet another example, chemical synthesis may be employed to obtain graphene by synthesizing graphene and subsequently reducing with hydrazine. Furthermore, properties and structure of graphene may depend on the technique employed for synthesis. Additionally, the chemical vapour deposition technique may be employed to obtain graphene sheets with least amount of impurities. Optionally, synthesised graphene may be functionalised with a functional group to enhance its properties and improve its interactability with substrate.

Moreover, optionally, a functionalised graphene includes at least one functional group, for example, aliphatic ester, aromatic ester, amine, epoxide, carboxyl, hydroxyl, siloxanes, and silanes. More optionally, the functionalised group may include graphite oxide. Furthermore, the synthesized graphene may be reacted with a suitable compound to obtain functionalised graphene. Additionally, each of carbon atoms in the synthesised graphene comprises a delocalised electron. Consequently, a functional group may react with the carbon atoms thereof. In addition, functional groups of the functionalised graphene influence properties thereof. In an example, a functionalised graphene may include functional groups, epoxide and carboxylic acid.

Moreover, a graphene nanoplatelet refers to a small stack of sheets of graphene. In this regard a graphene sheet is a two-dimensional layer comprising a plurality of carbon atoms as is a single sheet of a graphite structure. Optionally, the graphene nanoplatelet has a thickness in a range of 5 nanometres to 10 nanometres. More optionally, the graphene nanoplatelet has a thickness up to 50 microns. Beneficially, unique size and platelet morphology of the graphene nanoplatelet makes it effective at providing barrier properties. Additionally, unbonded electrons in the sheet of graphene makes the graphene nanoplatelet excellent electrical and thermal conductor. Graphene nanoplatelets have been found to improve mechanical properties such as stiffness, strength and hardness of a biodegradable polymer matrix.

Optionally, the plurality of graphene nanoplatelets is composed of functionalized graphene, doped graphene, graphene oxide, reduced graphene oxide, or a combination thereof. It will be appreciated that graphene nanoplatelets manufactured using functionalized graphene comprise a stack of sheets of graphene, wherein the graphene sheets have functional groups associated therewith. In this regard, the functional groups attached at different points to the sheets may be same or different. Moreover, graphene nanoplatelets manufactured using doped graphene comprise a stack of sheets of graphene, wherein the sheets of graphene are doped with foreign atoms of another element. The graphene atoms may be doped with atoms of, for example, Nitrogen (N), Boron (B), Phosphorus (P) and Fluorine (F). Furthermore, graphene nanoplatelets manufactured using graphene oxide comprise a stack of sheets of graphene, wherein graphene sheets are formed having various oxygen-containing functionalities (such as, epoxide, carbonyl, hydroxyl, and so forth). Additionally, graphene nanoplatelets manufactured using reduced graphene oxide comprises graphene oxide that upon reduction contains oxygen by weight of graphene oxide in a range of 5% to 30%.

Optionally, the plurality of graphene nanoplatelets is in the form of quantum dots. It will be appreciated that the plurality of graphene nanoplatelets quantum dots are nanocrystals made from graphene, functionalized graphene, doped graphene, graphene oxide, and the like. The plurality of graphene nanoplatelets quantum dots are small enough to exhibit quantum mechanical properties.

Optionally, the plurality of graphene nanoplatelets may comprise a low amount (e.g. <10% oxygen atoms with respect to carbon atoms) of functionable oxygen atoms. In this regard, the plurality of graphene nanoplatelets are treated chemically in order to be dispersed in the matrix of biodegradable polymer. Notably, the chemical treatment provides additional mechanical strength and barrier properties to the plurality of graphene nanoplatelets. Moreover, the chemical treatment strengthens the interface and load transfer in a sandwich-like matrix of biodegradable polymer. Specifically, the chemical treatment comprises treating a virgin plurality of graphene nanoplatelets with reagents that instil functional groups in a manner that planar structure of the plurality of graphene nanoplatelets is retained, for a pre-determined time period and a pre-determined temperature. Optionally, the pre-determined time period is 1 hour. More optionally, the pre-determined temperature is 80° C. It will be appreciated that the virgin graphene nanoplatelets refer to the graphene nanoplatelets in a raw form.

More optionally, the chemical treatment process comprises a step of activating the plurality of graphene nanoplatelets, comprising low functionable oxygen atoms, with an activating agent. The term “activating agent” refers to a composition, compound or substance which promotes dispersion of the plurality of graphene nanoplatelets in solid state in dispersion media, i.e. the matrix of biodegradable polymer. Suitable activating agents may be selected from a group comprising thionyl chloride, Benzotriazol-1-yloxy-tris[dimethylamino]phosphonium hexafluorophosphate (BOP), 3-diethyoxyphosphoryloxy-1,2,3-benzotriazin-4(3H)-one (DEPBT), N,N′-Dicyclohexylcarbodiimide, N,N′-Diisopropylcarbodiimide, 4-(4,6-dimethoxy-1,3,5-triazin-2-yl)-4-methylmorpholinium chloride (DMTMM), 1-[bis(dimethylamino)methylene]-1H-1,2,3-triazolo[4,5-b]pyridinium-3-oxide (HATU), 2-(1H-benzotriazol-1-yl)-1,1,3,3-tetramethyluronium hexafluorophosphate (HBTU), 1H-(6-chlorobenzotriazol-1-yl)-1,1,3,3-tetramethyluronium hexafluorophosphate (HCTU), 1-Hydroxy-7-azabenzotriazole, Hydroxybenzotriazole, (7-azabenzotriazol-1-yloxy)tripyrrolidinophosphonium hexafluorophosphate (PyAOP) reagent, (benzotriazol-1-yloxy)tripyrrolidinophosphonium hexafluorophosphate (PyBOP), Thiocarbonyldiimidazole, and the like.

Moreover, optionally, the chemical treatment process comprises a step of functionalizing the plurality of activated graphene nanoplatelets with a nucleophilic agent (or nucleophile). The term “nucleophilic agent” refers to a composition, compound or substance that donates an electron pair to form chemical bond in a reaction. Examples of activating agent may include, alkyl amine, aromatic amines, functionalized amines, alkanols or other nucleophilic entities.

Furthermore, optionally, the chemical treatment process comprises a step of filtering the plurality of treated virgin graphene nanoplatelets. The treated virgin graphene nanoplatelets are filtered and washed with hot water and cold water alternatively several times to remove by-products of chemical treatment performed on the plurality of virgin graphene nanoplatelets. Optionally, the plurality of filtered and washed virgin graphene nanoplatelets are then dried in oven at a temperature of 90° C.

It will be appreciated that polymers are large molecules, or macromolecules, composed of a plurality of repeated subunits. Specifically, small molecules (namely, monomer) of one or more compounds (for example, hydrocarbons) are repeated to form a matrix of a polymer. Optionally, the monomers of a compound are in admixture with other components of a formulation (for example, monomer of other compounds, ligands, and the like), followed by polymerization thereof to result in the matrix of polymer.

Optionally, the matrix of polymer is at least one of: a natural polymer, a synthetic polymer. More optionally, natural polymers include biodegradable polymers, for example, cellulose, hemp, shellac, chitosan, amber, wool, silk, natural rubber, Polybutylene succinate (PBS), and natural polyesters (such as, Polyhydroxyalkanoates (PHA), Polyhydroxybutyrate (PHB), Poly(3-hydroxybutyrate-co-3-hydroxyvalerate) (PHBV)). Moreover, synthetic polymers include, for example, Polyethylene (PE), Polypropylene (PP), Polystyrene (PS), Polyethylene terephthalate (PET), Polyvinyl butyral (PVB), Synthetic Rubber, Neoprene, Nylon, Silicone, and synthetic polyesters (for example, Polylactic acid (PLA)).

Pursuant to embodiments of the present disclosure, the matrix of polymer is a matrix of biodegradable polymer. It will be appreciated that the matrix of biodegradable polymer breaks down after its intended purpose by, for example, bacterial decomposition process, to result in natural by-products, such as, gases (CO₂, N₂), water, biomass, and inorganic salts. The matrix of biodegradable polymer is naturally occurring or synthetically made. Optionally, the matrix of biodegradable polymer consists of functional groups, for example, ester, amide and ether. In an example, the matrix of biodegradable polymer is composed of Polyhydroxyalkanoate (PHA) polymers, such as, PHB, PHBV, and so forth.

In an example, the matrix of biodegradable polymer is composed of Polylactic acid (PLA). In another example, the matrix of biodegradable polymer is composed of Polyhydroxybutyrate (PHB).

Optionally, the method further comprises extruding the matrix of biodegradable polymer prior to dispersing the plurality of graphene nanoplatelets thereon. In this regard, the matrix of biodegradable polymer is extruded using at least one screw. Herein, the at least one screw is driven at a faster advance through a heated extruder barrel.

Optionally, the at least one screw is formed geometrically in such a way that it drives the volume matrix of biodegradable polymer forward through the heated extruder barrel faster than what is possible with a conventional screw geometry designed for more heat tolerant polymers.

Optionally, the extrusion is performed using a more than one screw and heated barrel extruder.

More optionally, a two or more screws geometry (for example, twin screw geometry, and the like) is formed geometrically in a way to effectuate that a bare minimum of the polymer matrix is in contact with the elevated temperature heated extruder barrel, and in this manner the polymer matrix is less exposed to thermal degradation. It will be appreciated that the matrix of biodegradable polymer, generally, has poor thermal degradation resistance. Beneficially, extruding the matrix of biodegradable polymer eliminates onset of thermal degradation of the matrix of biodegradable polymer.

The method comprises dispersing the plurality of graphene nanoplatelets into the matrix of biodegradable polymer. In this regard, the matrix of biodegradable polymer acts as a dispersion medium for the plurality of graphene nanoplatelets, wherein the matrix of biodegradable polymer provides a continuous or external phase of dispersion for the plurality of graphene nanoplatelets. Optionally, the matrix of biodegradable polymer may be in solid state, liquid state, semi-solid state, or gaseous state. In an instance, the matrix of biodegradable polymer is a solid dispersion medium.

Notably, the graphene-polymer nanocomposite formed by dispersing the plurality of graphene nanoplatelets into the matrix of biodegradable polymer has a high degree of exfoliation. Moreover, the graphene-polymer nanocomposite displays good bonding between the plurality of graphene nanoplatelets and chains of polymer in the matrix of biodegradable polymer. Additionally, the graphene-polymer nanocomposite has increased thermal conductivity. Subsequently, heating and cooling of the graphene-polymer nanocomposite is more evenly distributed and time-efficient. Moreover, increased thermal conductivity of the graphene-polymer nanocomposite eliminates occurrence of excessive temperature zones in the graphene-polymer nanocomposite that causes thermal degradation thereof. In an example, the graphene-polymer nanocomposite is formed into fibres of diameter 2 mm.

The dispersion may be facilitated by incorporating a dispersing medium with the graphene nanoplatelets and the polymeric substrate. The dispersion medium is a synthetic compound that provides external and continuous phase of dispersion for the graphene nanoplatelets in the polymeric substrate. The dispersion media may be liquids, solids, and so forth. Liquid dispersion media may be solvents, mixtures of solvents, any other substance, composition, compound, and so forth, which exhibits liquid properties at room or elevated temperatures. Examples of liquid dispersion media may include, but are not limited to polyethylene glycol ether, castor oil, vegetable wax and water. Solid dispersion media may be at least one of: polymers (such as a solid or melted polymer, namely polymer melt), glasses, metals, metal oxides and so forth.

Optionally, a ultrasonication method may be used to disperse the graphene nanoplatelets in the polymeric substrate. In the ultrasonication method, ultrasound energy is applied to agitate the graphene nanoplatelets and polymeric substrate in the dispersing medium. When ultrasound propagates via a series of compression, attenuated waves are induced in the molecules of the dispersing medium. Such shock waves promote the ‘peeling off’ of the outer part of the graphene nanoplatelets and thus producing the separation of individualized graphene nanoparticle. The ultrasonication method is an effective method to disperse and exfoliate graphene and obtain stable suspensions in various dispersing medium with a low viscosity, such as water, acetone and ethanol. It should be noted that both of frequency of ultrasound (most commonly used zone: 10-50 kHz) and treatment time are crucial parameters for the integrity of graphene structure and its dispersion state in polymer.

Optionally, a calendering method (for example, three-roll mill method) may be used to disperse the graphene nanoplatelets in the polymeric substrate. In three-roll mill method, shear force is employed by rollers to disperse the graphene nanoplatelets in the polymeric substrate. For instance, three-roll mill consists of three adjacent cylindrical rolls where three rolls turned at the different angular velocity ratio. The first and third rolls rotated in the same direction while the centre roll rotated oppositely. Adjusting the gap distance and nip force between rolls resulted in high shearing stress, which could break up the nanoparticle agglomerates and hence generate highly dispersed polymer dispersion. the dispersion state of the graphene nanoplatelets may be tuned by changing the gap between the adjacent rolls. A serial of polymer composites with low loading of reduced graphene oxide (RGO) sheets have been prepared by using the calendering process.

Optionally, an extrusion method may be used to disperse graphene into solid polymers like most thermoplastics. Twin screws in extruder hopper rotate at a high speed generating high shear flow through adjusting various parameters such as screw geometry, screw speed, temperature and time that leads to graphene dispersing and mixed with polymer matrix. The extrusion method meets large-scale production of polymer composites, which has been used for fabricating high-performance graphene-polymer composites.

In an example implementation, the matrix of biodegradable polymer, preferably in a liquid form, is spread over a platform, for example, a glass substrate. The plurality of graphene nanoplatelets, are dispersed in the matrix of biodegradable polymer spread over the platform. Furthermore, the plurality of graphene nanoplatelets dispersed in the matrix of biodegradable polymer is mixed to form the graphene-polymer nanocomposite. Subsequently, the aforementioned dispersion of the plurality of graphene nanoplatelets is iterated to obtain multiple layers of graphene-polymer nanocomposite. Moreover, optionally, the plurality of graphene nanoplatelets are dispersed by continuous stirring of molten matrix of biodegradable polymer after the dispersion of the plurality of graphene nanoplatelets.

Optionally, the glass substrate is a polytetrafluoroethylene (PTFE) film on top of a glass. PTFE film is extremely durable and provides strength to the glass and prevents it from chemical damaging and/or cracking or breaking. Moreover, PTFE has a very low coefficient of friction, therefore resists solids to stick on it. Furthermore, PTFE is hydrophobic and thus provides high resistance to moisture or flowing liquids. Alternatively, the glass substrate may be a silicone-coated glass substrate, a PTFE glass mesh, a PEEK-coated glass substrate, and the like. Alternatively, optionally, the platform may be a PTFE-coated carbon material, a PTFE-coated graphite material, a PTFE-coated bronze material, a PTFE-coated metal, an all-metal design, such as stainless steel, and so forth.

In another example implementation, the plurality of graphene nanoplatelets are polarically aligned in the matrix of biodegradable polymer. The aforementioned method of manufacture of graphene-polymer nanocomposite comprises interaction of functional groups of the matrix of biodegradable polymer with functional groups of the plurality of graphene nanoplatelets. Notably, the plurality of graphene nanoplatelets are polarically aligned using polar or non-polar interactions between the functional groups of the matrix of biodegradable polymer and the plurality of graphene nanoplatelets dispersed therein. Typically, stronger binding between the matrix of biodegradable polymer and the plurality of graphene nanoplatelets dispersed therein facilitate improved barrier properties and conductivity (both electrical and thermal) in the resultant graphene-polymer nanocomposite.

Optionally, the dispersed plurality of graphene nanoplatelets are allowed to interact with the matrix of biodegradable polymer for a predefined time duration at predefined temperature, for example for 1 hour at a temperature of 80° C. More optionally, the resultant graphene-polymer nanocomposite is then filtered and washed. Notably, the graphene nanoplatelets strengthen the interface and load transfer, thereby providing additional mechanical strength to the graphene-polymer nanocomposite.

More optionally, the graphene-polymer nanocomposite is further dispersed in at least one solvent, wherein a solvent is at least one of: a plasticizer, a stabilizer, a filler, an impact modifier. In this regard, plasticizer refers to a solvent that acts as an agent which, for example, softens, makes more flexible, malleable, pliable, and plastic, the graphene-polymer nanocomposite. The plasticizer provides flexibility, pliability, and durability that further decreases melting temperature and glass transition temperature of the graphene-polymer nanocomposite. Examples of plasticizer include, but are not limited to, tributyl citrate, acetyl tributyl citrate, diethyl phthalate, glycerol triacetate, glycerol tripropionate, triethyl citrate, acetyl triethyl citrate, phosphate esters (for example, triphenyl phosphate, resorcinol bis(diphenyl phosphate), and olicomeric phosphate), long chain fatty acid esters, aromatic sulfonamides, hydrocarbon processing oil, propylene glycol, epoxy-functionalized propylene glycol, polyethylene glycol, polypropylene glycol, partial fatty acid ester (for example, Glycerol monostearate (GMS), Loxiol GMS 95), glucose monoester (Dehydrat VPA 1726), epoxidized soybean oil, acetylated coconut oil, linseed oil, and epoxidized linseed oil.

Optionally, a filler may be added to alter mechanical properties, physical properties and/or chemical properties of the graphene-polymer nanocomposite. Examples of filler include, but are not limited to, magnesium oxide, hydrous magnesium silicate, aluminium oxides, silicon oxides, titanium oxides, calcium carbonate, clay, chalk, boron nitride, limestone, diatomaceous earth, mica, glass quartz, ceramic and/or glass microbeads, metal or metal oxide fibres and particles, Magnetite®, Magnetic Iron(III) oxide, carbon nanotubes and fibres.

Additionally, optionally, a stabilizer may be added, which may be at least one of: a thermal stabilizer, an oxidative stabilizer, light stabilizer. Typically, thermal stabilizer when added to the graphene-polymer nanocomposite, improves resistance to heat thereof, thereby enabling the graphene-polymer nanocomposite to sustain its properties at higher temperatures. In an example, the thermal stabilizer is hydrogen chloride scavenger (such as, epoxidized soybean oil). Moreover, oxidative stabilizer when added to the graphene-polymer nanocomposite improves resistance of the graphene-polymer nanocomposite to oxidative damages due to oxidation by atmospheric air, corrosive or other reactive chemicals (for example, acids, peroxides, hypo chlorides, and ozone). Optionally, the oxidative stabilizer used is at least one of: alkoxy substituted hindered amine light stabilizers (HALS) (for example, N-O-R HALS), N-(1,3-dimethylbutyl)-N′-phenyl-p-phenylenediamine (6PPP), N-isopropyl-N-phenyl-phenylenediamine (IPPD), 6-ethoxy-2,2,4-trimethyl-1,2-dihydroquinoline (ETMQ), ethylene diurea (EDU), and paraffin wax. Furthermore, light stabilizer when added to the graphene-polymer nanocomposite improves resistance of the graphene-polymer nanocomposite to damage from exposure to natural or artificial light in a wide spectral range (for example, from deep UV to mid IR). Examples of light stabilizer include, ultra violet (UV) light stabilizers and hindered amine light stabilizers (HALS or HAS).

Furthermore, optionally, an impact modifier nay be added to increase resistance of the graphene-polymer nanocomposite against breaking, under impact conditions. Examples of impact modifier include, but are not limited to, polymers or copolymers of an olefin (for example, ethylene, propylene, a combination of ethylene and propylene with various (meth)acrylate monomers and/or various maleic-based monomers), alkyl(methyl)acrylates (for example, butyl acrylate, hexyl acrylate, propyl acrylate, or a combination thereof), alkyl(meth)acrylate monomer with acrylic acid (for example, maleic anhydride, glycidyl methacrylate, or a combination thereof), monomers providing additional moieties (for example, carboxylic acid, anhydride, epoxy), block copolymers (for example, A-B diblock copolymers, A-B-A triblock copolymers, and rubber block, B, derived from isoprene, butadiene or isoprene and butadiene).

Optionally, the graphene-polymer nanocomposite is formed by dispersing a plurality of functionalised graphene nanoplatelets into a matrix of biodegradable polymer (namely, a matrix of cellulose), mixing the plurality of functionalised graphene nanoplatelets with the matrix of cellulose and further dispersing the mixture of the plurality of functionalised graphene nanoplatelets and the matrix of cellulose in solvent (for example, plasticizer, stabilizer, filler and/or impact modifier). In this regard, the solvent may provide an ease of deposition of the dispersed mixture of the plurality of functionalised graphene nanoplatelets and matrix of cellulose on a layer of substrate and enhance properties thereof. Moreover, optionally, the solvent is biodegradable in nature.

Optionally, a concentration of the plurality of graphene nanoplatelets dispersed in the matrix of biodegradable polymer may be in a range of 0.05 to 20 weight %. Moreover, optionally, a concentration of the solvent may be in a range of 80 to 99.5 weight %.

More optionally, the solvent further includes a binder. More optionally, the binder may enhance adhesive properties of the graphene-polymer nanocomposite. Furthermore, the binder may be added to the solvent prior to dispersion of the mixture of the plurality of functionalised graphene nanoplatelets and the matrix of cellulose. Additionally, optionally, nature and/or functional group of the binder may be compatible and/or similar to the plurality of functionalised graphene nanoplatelets. Examples of the binder may include but, are not limited to, natural and synthetic rubbers, alkane polymers, alkene polymers, polyamides, polyurethanes and so forth. Moreover, the binder may be compatible with the solvent and a functional group of the plurality of functionalised graphene nanoplatelets to enable interaction therebetween.

Moreover, the method comprises extruding the matrix of biodegradable polymer containing the plurality of graphene nanoplatelets to obtain the biodegradable polymer nanocomposite. It will be appreciated that extrusion is a process for creating objects of a fixed cross-sectional profile. Pursuant to embodiments of the present disclosure, extrusion is performed strategically and precisely to create (namely, produce) the biodegradable polymer nanocomposite from the graphene-polymer nanocomposite. In this regard, pellets, powder or flakes of the graphene-polymer nanocomposite are pushed through a shaping tool (for example, a die) of desire cross-section, wherein compressive stress and shear stress acts thereon when it is pushed through the shaping tool. Optionally, the pellets are melted in an extruder to perform extrusion thereon. Subsequently, a cross-linking between molecules of the graphene-polymer nanocomposite is formed during heating and melting thereto, in the extruder. Beneficially, extruding the graphene-polymer nanocomposite enables production of complex cross-sections of the graphene-polymer nanocomposite.

Optionally, the extrusion is performed using single or multiple screw and barrel extruder. Herein, the pellets of the graphene-polymer nanocomposite are fed into a barrel of an extruder through a hopper. It will be appreciated that heating elements are placed over the barrel to heat the barrel so as to melt the pellets therein. Moreover, the pellets are then conveyed forward by a rotating screw and forced through a shaping tool or a die. Subsequently, molten pellets of graphene-polymer nanocomposite are converted to continuous biodegradable polymer nanocomposite. Moreover, thermocouples are attached to the barrel to sense and subsequently control a temperature of the barrel thereby controlling a temperature of the molten pellets. Moreover, the continuous biodegradable polymer nanocomposite that is forced through the die is cooled by blown air or water bath.

Optionally, the screw of the extruder has a diameter in a range of 25 millimetres (mm) to 250 millimetres (mm). Moreover, a length to diameter ratio of the extruder is in a range of 15 to 40. Additionally, a speed of rotation of the screw is in a range of 20 rotations per minute (RPM) to 150 RPM. Furthermore, optionally, depth of conveying channel of the screw is contoured from large to small in a flow direction of the molten graphene-polymer nanocomposite so as to account for density change of the graphene-polymer nanocomposite from solid state to liquid state and for pressure development.

In an instance, the extruder is a single screw extruder (SSE). In another instance, the extruder is a twin screw extruder (TSE). In such case, the graphene-polymer nanocomposite is conveyed through the barrel with two screws. Moreover, the two screws of the TSE may be co-rotating intermeshing, counter rotating intermeshing or counter rotating non-intermeshing. Optionally, the two screws of the TSE have same diameter and same speed. Pursuant to embodiments of the present disclosure, twin screw extruder is employed.

More optionally, shear developed between the screws, e.g. between the two screws in a twin screw configuration, or shear developed in the annulus between a screw and a barrel of the screw and barrel extruder is sufficient to deagglomerate agglomerated graphene nanoplatelets in the matrix of biodegradable polymer. It will be appreciated that mixing the plurality of graphene nanoplatelets with the matrix of biodegradable polymer leads to contact between the plurality of graphene nanoplatelets.

Subsequently, the plurality of graphene nanoplatelets tend to agglomerate as they come in contact with each other, owing to Van der Waals static forces acting therebetween. Such agglomeration of the plurality of graphene nanoplatelets turn the plurality of graphene nanoplatelets into graphite that is different and undesirable. Therefore, the extruder is designed in a manner that the extruder allows for maximum shear force in the annulus between the two screws in a twin-screw configuration and in an annulus between screw(s) of the extruder and the barrel thereby ensuring that the plurality of graphene nanoplatelets that may have agglomerated will deagglomerate so that they are in the same form as originally exfoliated graphene, with the help of shear force acting on the graphene-polymer nanocomposite, in the extruder.

Moreover, optionally, shear developed in a space between surfaces of two or more screws that are rubbing close to each other and/or in the annulus between the screws and the heated barrel of the screw and barrel extruder is sufficient to deagglomerate agglomerated graphene nanoplatelets in the matrix of biodegradable polymer.

Additionally, optionally, the extrusion is performed at a temperature in a range of 120 degree Celsius to 160 degree Celsius. It will be appreciated that the barrel of the extruder has heating elements attached thereto. Optionally, the extruder has different heating element for different zones, wherein heating element for a zone may be regulated based on desired temperature for the zone. Subsequently, optionally, the barrel may comprise different temperature zones, wherein each zone has a temperature required for operation in the said zone. Alternatively, optionally, same temperature is maintained throughout the barrel by the heating elements of the extruder. Following extrusion, the biodegradable polymer composite may be cooled, typically to room temperature, to solidify it. This ensures that the structural characteristics are preserved.

In an example, the heating elements heat the barrel to 155 degree Celsius for extrusion of the graphene-polymer nanocomposite. Moreover, the diameter of an extruder used for extruding the graphene-polymer nanocomposite may be 16 mm. Moreover, optionally, to obtain accurate diameter tolerance of extruded graphene-polymer nanocomposite (namely, biodegradable polymer nanocomposite) a tolerance puller and/or a filament winder is employed.

Notably, the biodegradable polymer nanocomposite formed by dispersing the plurality of graphene nanoplatelets onto the matrix of biodegradable polymer, mixing thereto and further extruding the mixture (namely, graphene-polymer nanocomposite) using a screw-barrel extruder offers high mechanical strength thereby making the biodegradable polymer nanocomposite stronger, thinner, lighter, less wasteful and more economic as compared to conventional bio-based plastics. In an example, the matrix of biodegradable polymer is composed of PLA. In such case, the graphene-infused PLA offers up to 60% elasticity, as compared to 7% elasticity of neat PLA, 5% elasticity of PHB and 50% elasticity of nylon.

Additionally, the biodegradable polymer nanocomposite offers enhanced barrier properties thereby stopping unwanted flow of liquid, gas and odour therethrough. In another example, the matrix of biodegradable polymer is composed of PHA. In such case, with 1 weight % (wt %) loading of graphene nanoplatelets on the PHA matrix, Water Vapour Transmission Rate (WVTR) of the graphene-infused PHA reduces by 25% from 2.4 gram (g)/metre² (m²)/day of neat PHA to 1.4 g/m²/day. In yet another example, the matrix of biodegradable polymer is composed of cellulose acetate. In such case, with 0.8 wt % loading of graphene nanoplatelets on the cellulose acetate matrix, WVTR of the graphene-infused cellulose acetate reduces by 47%. Furthermore, 0.001 wt % loading of graphene nanoplatelets on a matrix of polyimide, wherein the graphene nanoplatelets are composed of graphene oxide nanoparticles, reduces WVTR of graphene oxide-infused polyimide by 83%. Optionally, the plurality of graphene nanoplatelets used for performing the aforesaid method have high aspect ratio that attribute to further enhanced resistance to permeability (namely, barrier properties).

Moreover, the plurality of graphene nanoplatelets dispersed onto the matrix of biodegradable polymer provides more UV absorbing properties thereby shielding material packed or stored in the biodegradable polymer nanocomposite (namely, graphene-infused polymer) from premature degradation due to UV. In an instance, with 2 wt % loading of graphene nanoplatelets on a matrix of Sodium Alginate, wherein the graphene nanoplatelets are composed of graphene oxide, thermal degradation of the graphene-infused Sodium Alginate reduces by 20%.

Additionally, the biodegradable polymer nanocomposite (specifically, graphene-infused polymer) offers enhanced resistance to heat, improved thermal stability and improved thermal properties. In this regard, the plurality of graphene nanoplatelets serve as heterogenous nucleation agent for the matrix of biodegradable polymer thereby decreasing induction period of crystallization and accelerating overall crystallization rate of the graphene-infused polymer. Dispersing the plurality of graphene nanoplatelets leads to lower crystallization activation energy and higher crystallinity for graphene-infused polymer. In an instance, the plurality of graphene nanoplatelets are composed of graphene oxide nanoparticles and the matrix of biodegradable polymer is composed of PLA. In such case, with 0.5 wt % loading of graphene nanoplatelets on the PLA increases melting temperature of graphene-infused PLA by 6 degrees Celsius over that melting temperature of neat PLA.

Moreover, the graphene-infused polymer offers improved manufacturing speed thereof owing to improvement in thermal properties. In an instance, loading 3 wt % of graphene nanoplatelets in an epoxy thermosetting polymer improves throughput of manufacturing of graphene-infused epoxy thermosetting polymer by 13%.

Optionally, a biodegradable packaging is manufactured using the biodegradable polymer nanocomposite, or obtained by performing the method for producing the biodegradable polymer nanocomposite. The biodegradable packaging exhibits improved mechanical properties, and liquid, gases and odour barrier properties. More optionally, the biodegradable packaging is manufactured from the biodegradable polymer nanocomposite using an electrically-assisted three-dimensional (3D) printing process. The electrically-assisted 3D printing process takes place in a tank, such as a glass tank. The matrix of biodegradable polymer in molten state, is filled and spread over the glass tank. The plurality of graphene nanoplatelets are dispersed in the matrix of biodegradable polymer. The plurality of graphene nanoplatelets dispersed in the matrix of biodegradable polymer are subjected to an electric current, for example, a direct-current of 1300 Volts (V), to generate an electric field of 433 Newton/Coulomb (N/C) in order to polarically align the plurality of graphene nanoplatelets in the matrix of biodegradable polymer. More optionally, the plurality of graphene nanoplatelets polarically aligned in the matrix of biodegradable polymer are subjected to light, such as ultraviolet light, to initiate the process of photocuring repeatedly to cure layers of the graphene-polymer polymer nanocomposite and to obtain the biodegradable packaging. Optionally, an intensity of light emitted from a light source is 3.16 milliwatts centimetre-2 (mW/cm²). In an instance, an optical microelectromechanical system (MEMS) of Digital Micromirror Device (DMD) light projection system, forming core of a trademarked DLP projection technology of Texas Instruments, may be used for photocuring. Alternatively, a range of digital light processing systems may be used for photocuring. Alternatively, optionally, lasers may be used for photocuring.

### Experimental

Materials & Methods

During the developments of embodiments of the technology described herein, multiple series of each of three PHA master batches of Plain Graphene, Graphene Oxide and reduced Graphene Oxide, each comprising a loading of 0.5% by weight of exfoliated graphene was prepared and each was used to make graphene/PHA composites containing various lower loadings of graphene. Comparative samples were prepared without graphene loading, i.e. with the pure PHA master batches.

The graphene was added to the PHA pellets and extruded at 155 degree Celsius through a Brabender Plastograph 815606 extruder of 16 mm diameter. To obtain accurate diameter tolerance of the extruded filaments a Nortek Tolerance Puller and a Nortek Filament Winder 2.0 was used.

The Ultimate Tensile Strength (UTS) of samples was measured according to ISO 527, using filaments of 2 mm diameter.

Results

The average measured improvements in UTS versus the reference sample for the Plain Graphene were 31% for the 0.5% load by weight samples, 21% for the 0.25% load, and 20% for the 0.1% load.

The average measured improvements in UTS versus the reference sample for the Graphene Oxide were 50% for the 0.5% load by weight samples, 62% for the 0.25% load, and 81% for the 0.1% load.

The average measured improvements in UTS versus the reference sample for the reduced Graphene Oxide were 50% for the 0.5% load by weight samples, 28% for the 0.25% load, and 30% for the 0.1% load.

1. A method for producing biodegradable polymer nanocomposite, the method comprising:
dispersing a plurality of graphene nanoplatelets into a matrix of biodegradable polymer; and
extruding the matrix of biodegradable polymer containing the plurality of graphene nanoplatelets to obtain the biodegradable polymer nanocomposite, using twin-screw and barrel extruder,
wherein the extruder is configured to allow for a maximum available shear force in an annulus between the two screws in a twin-screw configuration and in an annulus between the screws of the extruder and the barrel such that the shear developed between screws or between screw and barrel is sufficient to deagglomerate agglomerated graphene nanoplatelets in the matrix of biodegradable polymer and wherein a cross-linking between molecules of the graphene-polymer nanocomposite is formed during heating and melting in the extruder by heating elements placed over the barrel.

2. The method of claim 1, wherein the extrusion is performed at a temperature in a range of 120 degree Celsius to 160 degrees Celsius.

3. The method of claim 1, wherein a depth of the conveying channel of the screw is contoured from large to small in a flow direction of the molten biodegradable polymer nanocomposite to account for a density change of the biodegradable polymer nanocomposite from solid state to liquid state and to account for a pressure development.

4. The method of claim 1, wherein the matrix of biodegradable polymer is extruded at 155° C. through an extruder of 16 mm diameter.

5. The method of claim 1, wherein the method further comprises extruding the matrix of biodegradable polymer prior to dispersing the plurality of graphene nanoplatelets thereon, wherein the screws are driven at a faster advance through a heated extruder barrel.

6. The method of claim 1, wherein the plurality of graphene nanoplatelets is composed of: functionalized graphene, doped graphene, graphene oxide, reduced graphene oxide, or a combination thereof.

7. The method of claim 1, wherein the biodegradable polymer is composed of is composed of Polyhydroxyalkanoates (PHA) and the loading of graphene nanoplatelets on the PHA is 1% by weight.

8. The method of claim 1, wherein the biodegradable polymer is composed of cellulose acetate and the loading of graphene nanoplatelets on the cellulose acetate is 0.8% by weight.

9. (canceled)
